(19) United States
(12) Patent Application Publication
(10) Pub. No.: US 2004/0040927 A1
(43) Pub. Date: Mar. 4, 2004

(54) Container

(76) Inventors: Richard Stuart Little, Leeds (GB); Gordon Little, Leeds (GB)

Correspondence Address: VENABLE, BAETJER, HOWARD AND CIVILETTI, LLP, P.O. BOX 34385, WASHINGTON, DC, 20043-9998, US

(21) Appl. No.: 10/450,562

(22) PCT Filed: Dec. 12, 2001
(86) PCT No.: PCT/GB01/05491

(30) Foreign Application Priority Data
Dec. 22, 2000 (GB) 0031424.5

(51) Int. Cl. A23L 1/00

(52) U.S. Cl. 215/206; 99/275

(57) ABSTRACT

The invention provides a container (2) having primary and secondary compartments (2a, 2b) separated by an inner base (12). The primary compartment (2a) contains drink (10) and the secondary compartment (2b) contains a bag (14) which is firmly attached to the underside of the inner base (12) and maintained in a tightly folded configuration by a removable base (6). When an operator wishes to dispose of the container (2) and any partially consumed drink (10) contained therein, the base (6) is removed and the bag (14) is opened out, still attached to the container (2) and turned inside out so that the container (2) and any peripheral materials, for example a straw (8), may be accommodated therein.

The present invention relates to containers and particularly, although not exclusively, relates to containers for food and/or drink.

The fast food industry is prevalent in today's society with consumers being supplied with a variety of food and drinks in a range of different containers. In the majority of cases, the containers, for example, drinks cups, are supplied with a detachable lid which may often be damaged or lost during use. This results in the problem of how to effectively seal the container and any remaining unwanted food or drink therein, once the consumer has finished his or her meal. Furthermore, normally, fast food is consumed in areas away from refuse bins, for example, in a car. It is therefore often difficult to effectively and cleanly store the container, any unwanted food, and any peripheral refuse such as straws, sauce, sachets and serviettes, without running the risk of spilling the remaining food and losing the peripheral refuse.

It is one of the aims of embodiments of the present invention to address the above problems and to provide a container which may be effectively and cleanly disposed of.

According to the present invention, there is provided a container for materials, the container comprising at least one compartment in which said materials may be received, bagging means, and at least a second compartment in which the bagging means is stored in a first configuration, the bagging means being operable to be disposed in to a second configuration such that the container may be accommodated therein.

The materials may be articles and/or fluid or any combination thereof. The or each article or fluid may be accommodated by the bagging means together with the container when the bagging means is in the second configuration.

Preferably, the materials received in the or each compartment comprise food.

The term food extends to drink, however, it should be appreciated that the invention may be applied to any materials which may be stored in a container. Preferably, the container is for containing fast foods such as burgers, chips or drinks such as milkshakes, colas etc.

Preferably, the container is a liquids container, preferably, a drinks container.

Preferably, the second compartment is located substantially adjacent to the first compartment. Preferably, the second compartment is proximal to the base of the container. Preferably, the first compartment is proximal to the top of the container. Preferably, the second compartment is not in fluid communication with the first compartment, preferably, not in liquid communication with the first compartment.

However, it should be appreciated that the invention is not restricted to the relative locations of the first and second compartments. For convenience, for example when the container is a drinks container, it is preferred for balancing reasons only that the second compartment is located substantially underneath the first compartment.

Preferably, at least a part of the bagging means is secured to at least a part of the container by any suitable means, preferably, adhesive such as glue. Preferably, the bagging means is attached to the said second compartment, preferably, the interior thereof. Preferably, the bagging means is a bag, preferably, a plastic bag, which is, preferably, water tight. Alternatively, the bagging means may be a net or web depending on the size of the container and/or the materials intended to be accommodated therein.

Preferably, the bagging means is wholly contained in the first configuration in the second compartment by removable cover means attached to the container. The cover means may be a removable base of the container which is, preferably, attached to the lowermost part of the container by a hinge or is otherwise attached so that it may be opened without detaching from the container.

Alternatively, or additionally, the cover means may be attached to the container by a friction fit or adhesive seal.

Preferably, the bagging means is substantially tightly packed when stored in the first configuration.

Preferably, when the cover means is moved, the bagging means may be moved from its substantially packed first configuration into the substantially open second configuration with, preferably, the container still attached so that the bagging means may be turned inside out so that the container and/or materials may be accommodated therein.

Preferably, the bagging means comprises sealing means, which sealing means are operable to seal the bagging means when in the second configuration, in a third configuration. Preferably, when in the third configuration, the bagging means is substantially sealed such that solid and, preferably, liquid materials can not escape therefrom.

Preferably, when in the third configuration, the bagging means is substantially waterproof.

For a better understanding of the invention and to show how embodiments of the same may be carried into effect, reference will now be made, by way of example, to the accompanying diagrammatic drawings, in which:

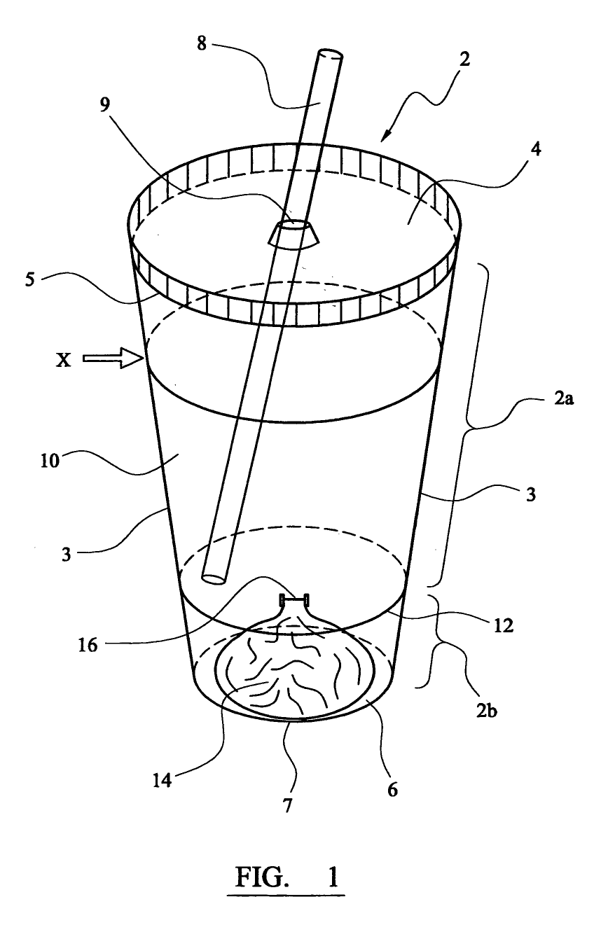

FIG. 1 is a sketched perspective view of a container in accordance with the present invention in a first configuration;

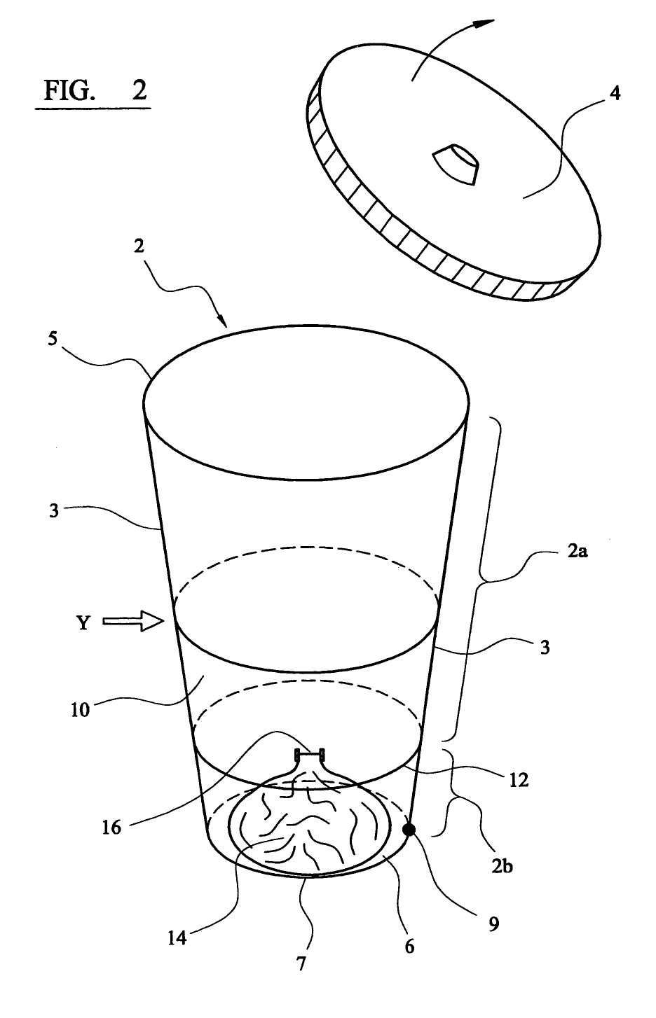

FIG. 2 is a sketched perspective view of the container shown in FIG. 1 in use;

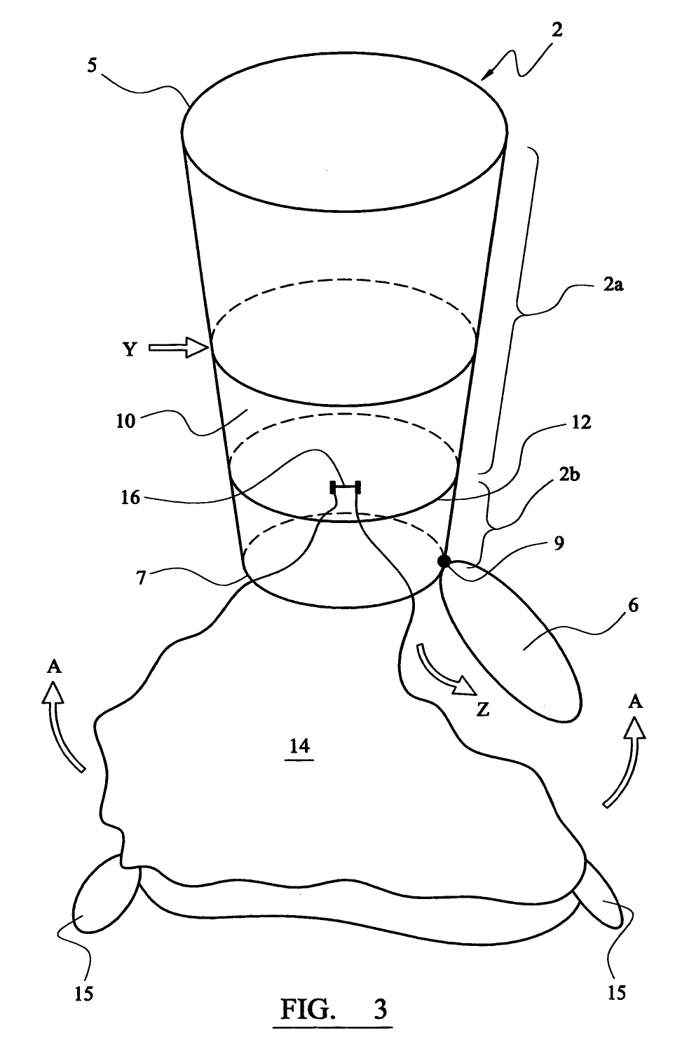

FIG. 3 is a sketched perspective view of the container in a second configuration;

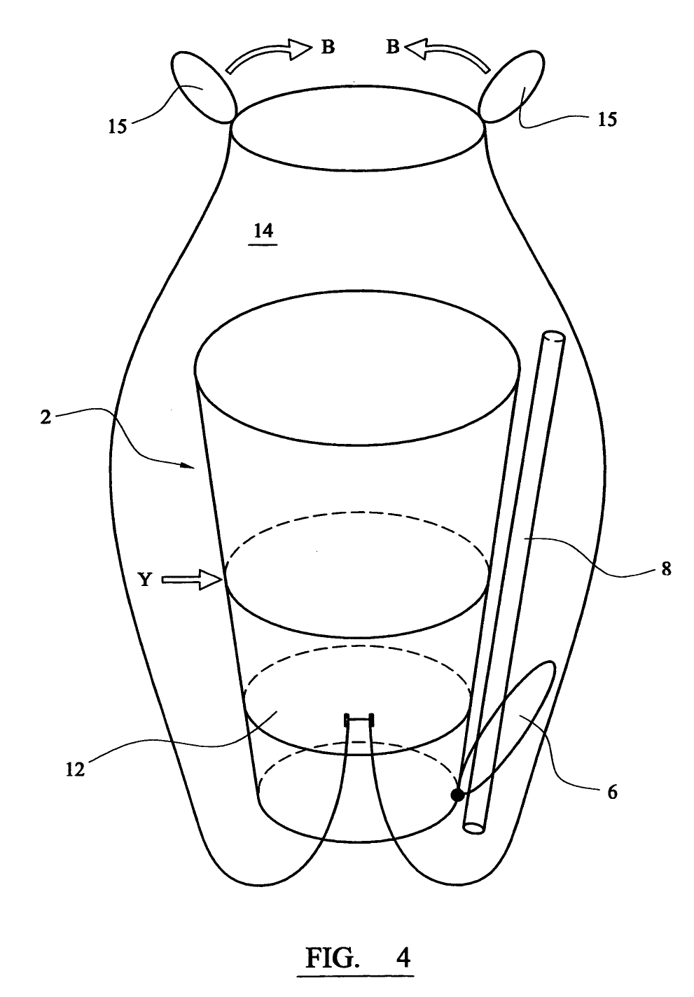

FIG. 4 is a sketched perspective view of the plane of the container in the third configuration; and

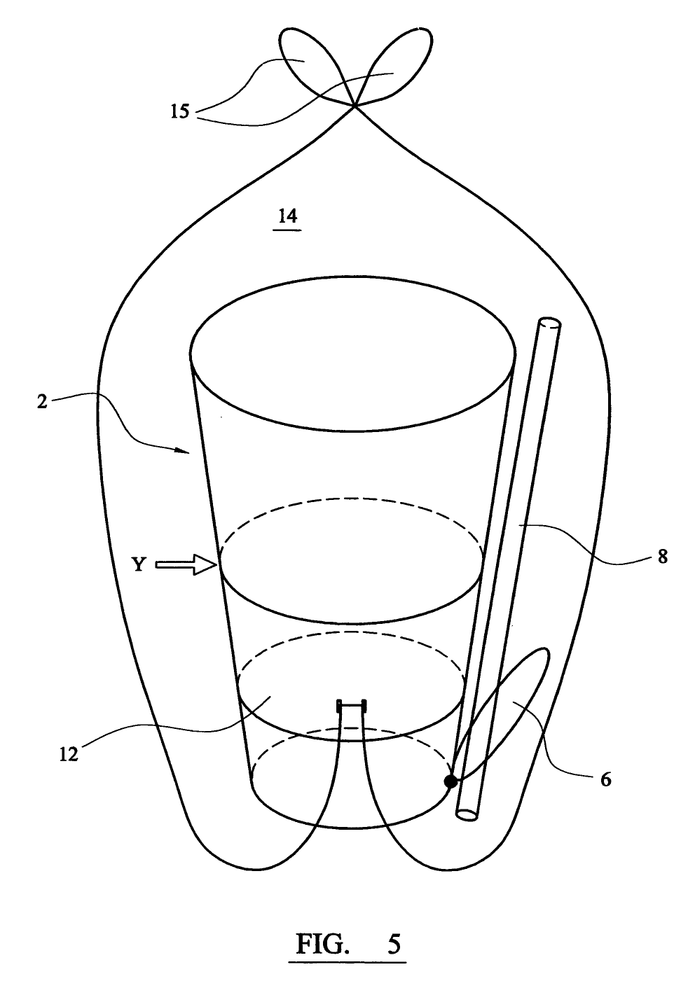

FIG. 5 is a sketched perspective view of the container in a fourth configuration.

Referring to FIG. 1, there is shown a frustoconical container 2, defined by an upper rim 5, a lower rim 7, an external base 6 (parallel with the plane of the lower rim 7 and spaced slightly inwardly therefrom) and container walls 3, comprising a primary compartment 2a and a secondary compartment 2b. The primary compartment 2a is defined by the upper portion of the walls 3 of the container 2 and an internal base 12 located about one quarter way up from the lower rim 7 and extending parallel with the plane of the exterior base 6 and upper rim 5 of the container and contains drink 10, for example, a fast food drink 10, such as a cola or milkshake. FIG. 1 shows the drink 10 in the primary compartment 2a up to the level as shown by arrow X. The container 2 has a detachable lid 4 for close fitting frictional engagement with the upper rim 5 of the container 2 which has a central aperture 9 extending therethrough for accommodating a straw 8 extending into the drink 10.

The secondary compartment 2b is defined by the underside of the internal base 12 and an external base 6 and contains a bag 14. The bag 14 is tightly folded up into a configuration such that it fits in the second compartment 2b and is firmly attached to the underside of the inner base 12, by adhesive. The external base 6 maintains the bag 14 in its tightly folded configuration.

Referring to FIG. 2, the container 2 is shown after a user has consumed a majority of the drink contents 10, the level of the drink 10 now being at a lower level as indicated by arrow Y in the primary compartment 2a. FIG. 2 indicates that the lid 4 has been either damaged or discarded and, that there is now the problem that the unwanted drink 10 still remaining within the primary compartment 2a may not be easily disposed of since the container 2 may not be effectively sealed. Therefore, the user has to maintain the container 2 in an upright position in order to avoid spilling the drink 10.

Referring to FIG. 3, the external base 6 is shown after it has been moved outwardly about a hinge 9 in the direction as illustrated by arrow Z. Alternatively, it will be appreciated that the external base 6 may be completely removed from the bottom of the container 2 in embodiments where hinge 9 is not provided. In such embodiments, the base 6 of the container 2 may be kept in position by a seal with bottom walls of the container 2 which is tight enough to maintain the base 6 and the bag 14 in position, but also loose enough so that it may be pulled away thereby freeing the bag 14. The user is then free to pull the bag 14 downwardly from out of the secondary compartment 2b in to a second, substantially unwrapped and open configuration whilst the container 2 is maintained in an upright position such that the liquid 10 remains therein.

The lower ends 15 of the bag 14 are then pulled outwardly and upwardly as illustrated by arrows A such that the bag 14 encloses the container 2 and the external base 6. In addition, the user may also insert into the bag 14 any peripheral articles such as the straw 8 or sauce sachets (not shown) which they may wish to dispose of together with the container 2 as shown in FIG. 4. Once the container 2 is enclosed by the bag 14, the ends of the bag 15 are brought together as illustrated by arrows B and securely tied together.

Referring to FIG. 5, the bag 14 is shown in a closed configuration. The bag 14 and contents may then be efficiently disposed of in a refuse bin (not shown) or, in circumstances when no refuse bins are available, the bag 14 may be safely stored without fear of the contents leaking out of the bag 14 until such a time that the bag 14 may be disposed of. Thus, the invention provides a simple, cheap and very convenient way of disposing of unwanted food or drink containers.

It will be appreciated that the invention is a very convenient way of incorporating a refuse bag 14 into a fast food container 2 and that the invention is not restricted to solely drinks containers as the bag 14 may be securely attached to, and concealed in, a wide range of other containers 2, for example, a hamburger packaging.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A container for materials, the container comprising at least one compartment in which said materials may be received, bagging means, and at least a second compartment in which the bagging means is stored in a first configuration, the bagging means being operable to be disposed in to a second configuration such that the container may be accommodated therein.

2. A container for materials according to claim 1, wherein the materials are articles and/or fluid or any combination thereof.

3. A container for materials according to claim 2, wherein the or each article or fluid is accommodated by the bagging means together with the container when the bagging means is in the second configuration.

4. A container for materials according to any preceding claim, wherein the materials received in the or each compartment comprise food.

5. A container for materials according to any preceding claim, wherein the container is a liquids container.

6. A container for materials according to any preceding claim, wherein the container is a drinks container.

7. A container for materials according to any preceding claim, wherein the second compartment is located substantially adjacent to the first compartment.

8. A container for materials according to any preceding claim, wherein the second compartment is proximal to the base of the container.

9. A container for materials according to any preceding claim, wherein the second compartment is not in fluid communication with the first compartment.

10. A container for materials according to any preceding claim, wherein at least a part of the bagging means is secured to at least a part of the container by any suitable means.

11. A container for materials according to any preceding claim, wherein the bagging means is attached to the said second compartment.

12. A container for materials according to any preceding claim, wherein the bagging means is attached to the interior of said second compartment.

13. A container for materials according to any preceding claim, wherein the bagging means is a bag.

14. A container for materials according to any preceding claim, wherein the bagging means is a net or web depending on the size of the container and/or the materials intended to be accommodated therein.

15. A container for materials according to any preceding claim, wherein the bagging means is wholly contained in the first configuration in the second compartment by removable cover means attached to the container.

16. A container for materials according to claim 15, wherein the cover means is a removable base of the container.

17. A container for materials according to either claim 15 or claim 16, wherein the cover means is attached to the lowermost part of the container by a hinge or is otherwise attached so that it may be opened without detaching from the container.

18. A container for materials according to any of claims 15 to 17, wherein the cover means is attached to the container by a friction fit or adhesive seal.

19. A container for materials according to any of claims 15 to 18, wherein when the cover means is moved, the bagging means may be moved from its substantially packed first configuration into the substantially open second configuration with the container still attached so that the bagging means may be turned inside out so that the container and/or materials may be accommodated therein.

20. A container for materials according to any preceding claim, wherein the bagging means comprises sealing means, which sealing means are operable to seal the bagging means when in the second configuration, in a third configuration.

21. A container for materials according to claim 20, wherein when in the third configuration, the bagging means is substantially sealed such that solid and liquid materials can not escape therefrom.

22. A container as substantially herein described with reference to, and as illustrated by, the accompanying drawings.
